(19) United States
(12) Patent Application Publication
(10) Pub. No.: US 2017/0316184 A1
(43) Pub. Date: Nov. 2, 2017

(54) INFORMATION PROCESSING DEVICE, INFORMATION PROCESSING METHOD, PROGRAM AND INFORMATION PROCESSING SYSTEM

(71) Applicant: SONY CORPORATION, TOKYO (JP)

(72) Inventors: SHIGEATSU YOSHIOKA, KANAGAWA (JP); MASATO KAJIMOTO, CHIBA (JP); YOICHI MIZUTANI, SAITAMA (JP); TAKU TANAKA, TOKYO (JP)

(21) Appl. No.: 15/522,767

(22) PCT Filed: Sep. 8, 2015
(86) PCT No.: PCT/JP2015/075414

§ 371 Date: Apr. 27, 2017

(30) Foreign Application Priority Data
Nov. 11, 2014 (JP) 2014-229109

(51) Int. Cl. G06F 19/00; G06F 19/18

(52) U.S. Cl. CPC G06F 19/366; G06F 19/18; G06F 19/3431

(57) ABSTRACT

[Object] It is desirable to realize a more efficient coordination between the genetic analysis company and the medical institution. [Solution] Provided is an information processing device including: a data acquisition unit configured to acquire predetermined information; a determination unit configured to determine whether or not personal information of a subject has been set in the predetermined information; and an identification information provision unit configured to provide a medical institution terminal with user identification information required when the subject uses a service, in a case where it is determined that the personal information of the subject has not been set in the predetermined information.

### TECHNICAL FIELD

The present disclosure relates to an information processing device, an information processing method, a program and an information processing system.

### BACKGROUND ART

In recent years, there are provided genetic analysis services that read genetic information from a specimen collected from a subject, analyze the read-out genetic information to acquire a genetic analysis result, and provide the subject with the acquired genetic analysis result. Such genetic analysis services mainly take a form in which the subject directly communicates with a genetic analysis company (DTC: Direct To Consumer).

With regard to the aforementioned form, there is a technique that allows provision of a genetic analysis service to a subject on the basis of user registration performed by the subject using a bar code included in an inspection kit. In addition, there is disclosed a technique that preliminarily provides a subject with a specimen ID and authentication information so as to allow provision of a genetic analysis service to the subject associated with the specimen ID and the authentication information (see, for example, Patent Literature 1).

### CITATION LIST

### Patent Literature

Patent Literature 1: JP 2009-87294A

### DISCLOSURE OF INVENTION

### Technical Problem

However, it is desirable that a subject is allowed to receive not only such a genetic analysis service provided by the genetic analysis company but also a consultation service by an expert in a medical institution. On this occasion, it is desirable to realize a more efficient coordination between the genetic analysis company and the medical institution.

### Solution to Problem

According to the present disclosure, there is provided an information processing device including: a data acquisition unit configured to acquire predetermined information; a determination unit configured to determine whether or not personal information of a subject has been set in the predetermined information; and an identification information provision unit configured to provide a medical institution terminal with user identification information required when the subject uses a service, in a case where it is determined that the personal information of the subject has not been set in the predetermined information.

In addition, according to the present disclosure, there is provided an information processing method including: acquiring predetermined information; determining whether or not personal information of a subject has been set in the predetermined information; and providing a medical institution terminal with user identification information required when the subject uses a service, in a case where it is determined that the personal information of the subject has not been set in the predetermined information.

In addition, according to the present disclosure, there is provided a program for causing a computer to function as an information processing device including: a data acquisition unit configured to acquire predetermined information; a determination unit configured to determine whether or not personal information of a subject has been set in the predetermined information; and an identification information provision unit configured to provide a medical institution terminal with user identification information required when the subject uses a service, in a case where it is determined that the personal information of the subject has not been set in the predetermined information.

There is provided an information processing system including: an information processing device including a data acquisition unit configured to acquire predetermined information, a determination unit configured to determine whether or not personal information of a subject has been set in the predetermined information, and an identification information provision unit configured to provide user identification information required when the subject uses a service, in a case where it is determined that the personal information of the subject has not been set in the predetermined information; a medical institution terminal including a communication unit configured to receive the user identification information from the information processing device; and a subject terminal including a communication unit configured to transmit a service use request including the user identification information to the information processing device.

### Advantageous Effects of Invention

According to the present disclosure described above, a more efficient coordination between a genetic analysis company and a medical institution may be realized. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram of the outline of a service assumed in an embodiment of the present disclosure;

FIG. 2 is an explanatory diagram of a process flow in an implementation body according to the embodiment;

FIG. 3 is an explanatory diagram illustrating GWAS specifically;

FIG. 4 illustrates an exemplary configuration of a curation DB;

FIG. 5 illustrates an exemplary configuration of genetic information;

FIG. 6 illustrates an exemplary configuration of a genetic analysis report;

FIG. 7 illustrates an exemplary functional configuration of an information processing device according to an embodiment of the present disclosure;

FIG. 8 illustrates an exemplary functional configuration of a medical institution terminal according to the embodiment;

FIG. 9 illustrates an exemplary functional configuration of an inspection institution terminal according to the embodiment;

FIG. 10 illustrates an exemplary functional configuration of a subject terminal according to the embodiment;

FIG. 11 illustrates a data flow when personal information is not transferred from a medical institution to a genetic analysis company;

FIG. 12 is a sequence diagram illustrating an operational flow of an information processing system when personal information is not transferred from a medical institution to a genetic analysis company;

FIG. 13 illustrates a data flow when personal information is transferred from a medical institution to a genetic analysis company;

FIG. 14 is a sequence diagram illustrating an operational flow of an information processing system when personal information is transferred from a medical institution to a genetic analysis company;

FIG. 15 is a sequence diagram illustrating an operational flow of an information processing system in an exemplary application of an embodiment of the present disclosure; and

FIG. 16 illustrates an exemplary hardware configuration of an information processing device according to the embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that, in this description and the drawings, structural elements that have substantially the same function and structure are sometimes distinguished from each other using different alphabets or numerals after the same reference sign. However, when there is no need in particular to distinguish structural elements that have substantially the same function and structure, the same reference sign alone is attached.

Description will be provided in the following order.

1. Embodiment
1-0. Outline of information processing system
1-1. Process flow in implementation body
1-2. Exemplary functional configuration of information processing device
1-3. Exemplary functional configuration of medical institution terminal
1-4. Exemplary functional configuration of inspection institution terminal
1-5. Exemplary functional configuration of subject terminal
1-6. Functional details of information processing system
1-7. Exemplary hardware configuration

2. Conclusion

### 1. EMBODIMENT

[1-0. Outline of Information Processing System]

First, there will be described an outline of an information processing system according to an embodiment of the present disclosure. In recent years, there are provided genetic analysis services that read genetic information from a specimen collected from a subject, analyze the read-out genetic information to acquire a genetic analysis result, and provide the subject with the acquired genetic analysis result. Such genetic analysis services mainly take a form in which the subject directly communicates with a genetic analysis company (DTC: Direct To Consumer).

With regard to the aforementioned form, there is a technique that allows provision of a genetic analysis service to a subject on the basis of user registration performed by the subject using a bar code included in an inspection kit. In addition, there is disclosed a technique that preliminarily provides a subject with a specimen ID and authentication information so as to allow provision of a genetic analysis service to the subject associated with the specimen ID and the authentication information (see, for example, Patent Literature 1).

With regard to the aforementioned form, a subject himself/herself may collect saliva as a specimen and mail it to a genetic analysis company, which brings about a merit that the time during which the subject is constrained is not very long. In addition, there is also a merit that the subject may be frequently notified of the situation of genetic analysis by the genetic analysis company via the Internet. With the aforementioned form, however, there are demerits as described below.

The first demerit with the aforementioned form is that, due to the absence of face-to-face counseling with the subject by an expert in a medical institution, interpretation of the genetic analysis result may be different depending on the subject. Accordingly, there is a possibility that the subject, who is feeling uneasy, may rush into a hospital which does not take a preventive measure.

The second demerit is that it is impossible to provide the subject with a genetic analysis service taking into account the content of health check result or clinical records (medical history, measures, etc.) kept in the medical institution. Furthermore, the third demerit is that, even when a report about the subject's drug responsiveness is acquired as a genetic analysis result, it is difficult to take advantage of the report.

With demerits such as those described above, a genetic analysis service in the aforementioned form is confined to merely providing the subject with an opportunity to review his/her living habits and eating habits. The present specification, therefore, proposes a technique for allowing a subject to receive not only such a genetic analysis service provided by a genetic analysis company but also a consultation service by an expert in a medical institution. In addition, the present specification proposes a technique for providing a more efficient coordination between a genetic analysis company and a medical institution.

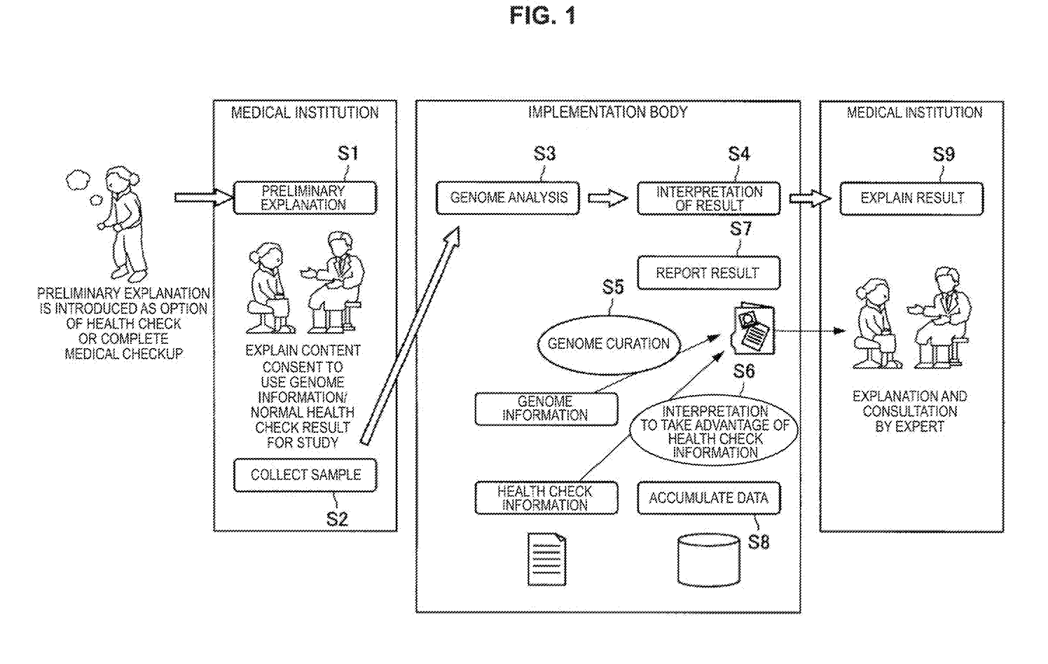

First, there will be described the outline of a service assumed in an embodiment of the present disclosure, referring to FIG. 1. FIG. 1 is an explanatory diagram of the outline of a service assumed in an embodiment of the present disclosure. As illustrated in FIG. 1, an expert in a medical institution first provides a preliminary explanation of the service to a subject who has visited the medical institution (S1). The preliminary explanation may be provided at any timing, or may be introduced as an option of the health check or complete medical checkup. In addition, explanation of the service content by the expert, or consent by the subject to use his/her genome information/normal health check result for study may be included in the preliminary explanation.

Upon completion of the preliminary explanation, a sample (specimen) is collected from the subject in the medical institution (S2). Subsequently, genome analysis of the subject's sample (specimen) is performed (S3) by an implementation body, which is a characteristic component in the embodiment of the present disclosure (and may correspond to, for example, the “genetic analysis company” and “inspection laboratory” in the example described below, and simply referred to as “implementation body” in the following). Genome information of the subject is read by the genome analysis. Subsequently, interpretation of the genome analysis result (genome information) is performed by the implementation body (S4), and the interpretation result is provided from the implementation body to the medical institution.

For example, the interpretation result by the implementation body is generated in the following manner. First, the implementation body performs genome curation (S5) for genome information and interpretation (S6) to take advantage of the subject's health check information, whereby a genome interpretation result report including the genome curation and the interpretation taking advantage of the health check information is generated as an interpretation result by the implementation body. The genome interpretation result report is provided to the medical institution. In addition, the genome interpretation result report may be accumulated as data in the implementation body for later use (S8).

Subsequently, the interpretation result provided by the implementation body is explained to the subject by the expert in the medical institution, and consultation to the subject may be performed by the expert in accordance with the interpretation result provided by the implementation body. With the form illustrated in FIG. 1, the subject is allowed to receive not only a mere genetic analysis service but also a consultation service by the expert in the medical institution on the basis of the interpretation result provided by the implementation body, according to the embodiment of the present disclosure.

Subsequently, there will be described the outline of the merit that may be received by the subject via the embodiment of the present disclosure. Initially, in the first-time genome health check (health check based on genome information), genome information read from the subject's sample (specimen) is accumulated in a genome DB of a genome health information platform (platform for managing the subject's health on the basis of the subject's genome information).

In addition, the genome interpretation result report generated by the genome health information platform is provided to a doctor as a report to the doctor. In the medical institution, on the basis of the report provided to the doctor as described above, the doctor grasps disease risks based on the genome information and provides health guidance. The timing of the first-time genome health check is not limited in particular.

Subsequently, as a continuous service, continued priority inspection in accordance with the disease risk, continued health guidance in accordance with the disease risk, or appropriate intervention due to a change in the health check result may be provided to the subject at the time of the subject's health check. The timing of the continuous service is not limited in particular. Disease prophylaxis or the like, which may be acquired from a prevention epidemiology DB on the basis of the health check data acquired through the service and genome information accumulated in the genome DB, may be useful for health guidance to individual subjects.

As thus described, it is possible to provide the subject with personalized healthcare administration as a continuous service, according to the embodiment of the present disclosure. In addition, data accumulated in the genome health information platform (for example, genome information, health check data, etc.) may be used for study, and the result of using for study may lead to improvement of service to the subject. In addition, such a continuous service may provide coordination with medical care in accordance with a healthcare event.

[1-1. Process Flow in Implementation Body]

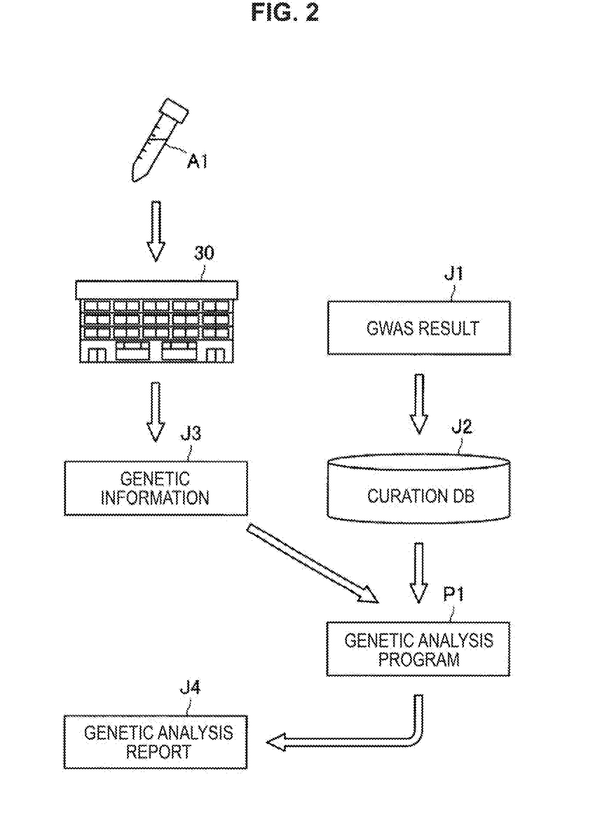

Subsequently, there will be described a process flow in the aforementioned implementation body. FIG. 2 is an explanatory diagram of a process flow in the implementation body according to the embodiment of the present disclosure. As illustrated in FIG. 2, a GWAS (Genome Wide Association Study) result J1 is reflected in a curation DB (J2). Here, GWAS may correspond to an approach of examining the difference of frequencies of SNP (Single Nucleotide Polymorphism) among certain groups over the entire genomic region. In addition, when there is observed a variation in the genome base sequence of a certain organism species group in which a single base has mutated, and the mutation within the group is observed with a frequency equal to or higher than 1%, the phenomenon is referred to as Single Nucleotide Polymorphism (SNP).

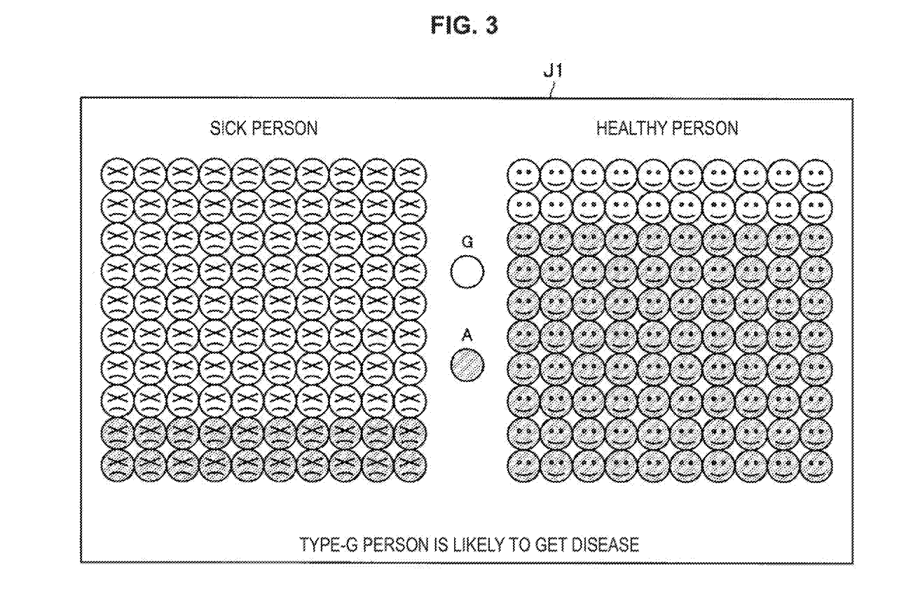

GWAS will be specifically described, referring to FIG. 3. FIG. 3 is an explanatory diagram illustrating GWAS specifically. Note that FIG. 3 is a partial excerpt taken from the content published in http://www.ims.u-tokyo.ac.jp/nakamura/matsuda/page3.html. As illustrated in FIG. 3, it is assumed that a knowledge has been acquired with regard to a certain base that a type-G person is more likely to get a disease than a type-A person. Such a knowledge is reflected in the curation DB (J2) as GWAS. Here, only such GWAS with a reliability equal to or higher than a certain degree may be reflected in the curation DB (J2).

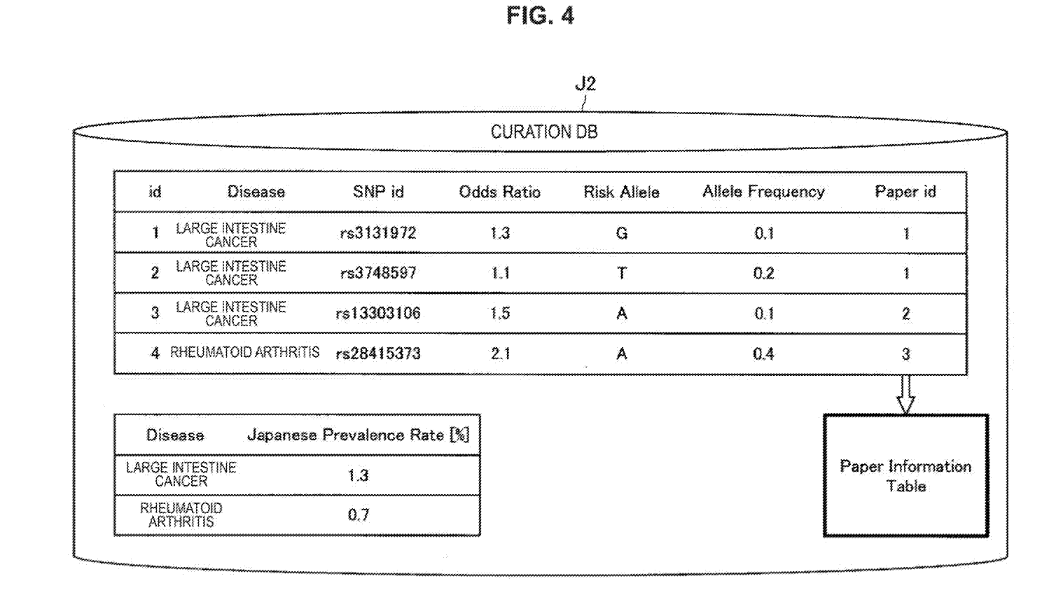

The curation DB (J2) will be specifically described, referring to FIG. 4. FIG. 4 illustrates an exemplary configuration of the curation DB. As illustrated in FIG. 4, curation data may include items such as “Disease”, “SNP id”, “Odds Ratio”, “Risk Allele”, “Allele Frequency”, and “Paper id”. Here, “Odds Ratio” may correspond to a statistical standard for indicating the likelihood of a certain phenomenon by comparing two groups. In addition, “Paper id” is an id of a table (Paper Information Table) relating to articles describing curation data.

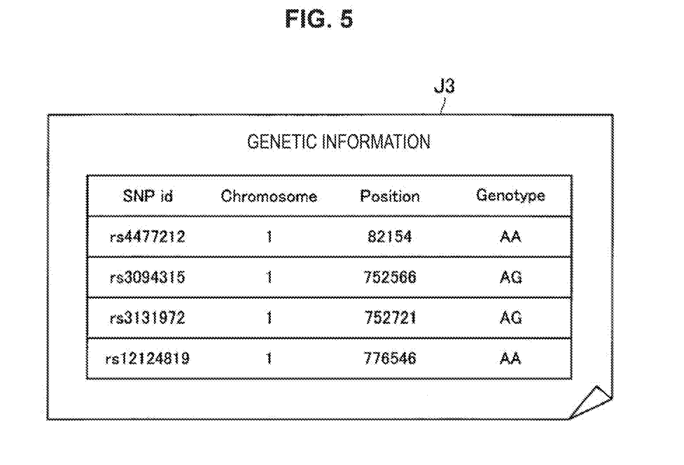

The explanation goes on, referring back to FIG. 2. As illustrated in FIG. 2, the curation data accumulated in the curation DB (J2) is provided to a genetic analysis program P1. On the other hand, a specimen A1 acquired from a subject is analyzed in an inspection laboratory 30, whereby genetic information J3 is acquired as a result of analyzing the specimen A1, as illustrated in FIG. 2. The genetic information J3 will be specifically described, referring to FIG. 5. FIG. 5 illustrates an exemplary configuration of the genetic information J3.

As illustrated in FIG. 5, the genetic information J3 may include items such as “SNP id”, “Chromosome”, “Position”, and “Genotype”. The configuration of the genetic information J3 is not limited to the example illustrated in FIG. 5. For example, it suffices that the genetic information J3 includes information for identifying the gene included in the specimen collected from the subject (for example, Chromosome in which the gene exists, Position and Genotype of the gene in Chromosome).

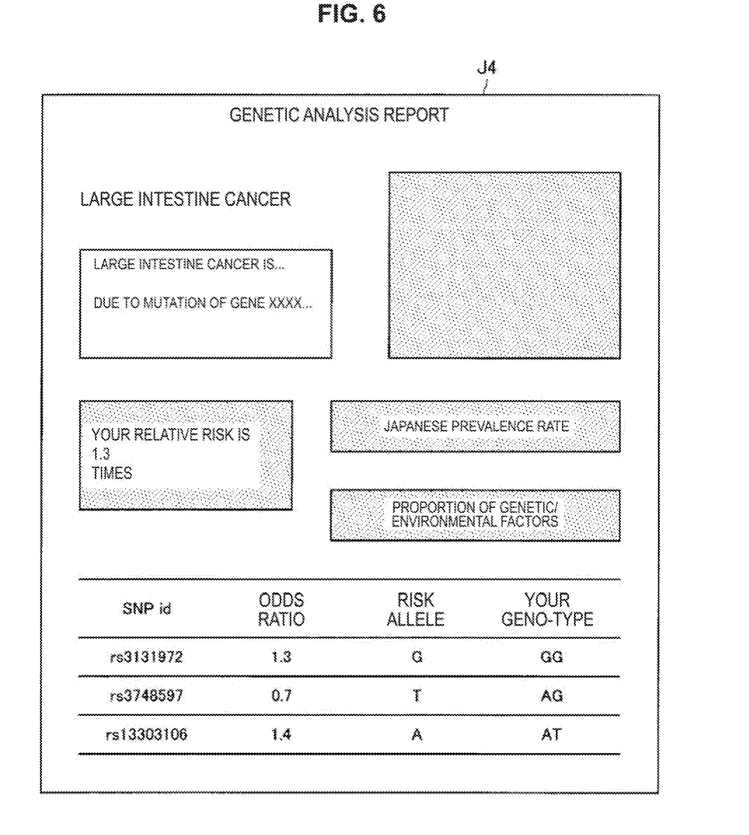

The explanation goes on, referring back to FIG. 2. The genetic information J3 thus acquired is also provided to the genetic analysis program P1. The genetic analysis program P1 generates a genetic analysis report J4 on the basis of the genetic information J3 and the curation data. There will be described an exemplary configuration of the genetic analysis report J4, referring to FIG. 6. FIG. 6 illustrates an exemplary configuration of the genetic analysis report J4. As illustrated in FIG. 6, the genetic analysis report J4, for example, may include information indicating the likelihood of a subject getting a predetermined disease (large intestine cancer in the example illustrated in FIG. 6).

For example, the genetic analysis report J4 thus generated is provided to a medical institution where an expert may grasp a disease risk and provide health guidance based on the genetic analysis report J4. In addition, the subject may directly acquire the genetic analysis report J4 by performing user registration. The process flow in the implementation body has thus been described above.

[1-2. Exemplary Functional Configuration of Information Processing Device]

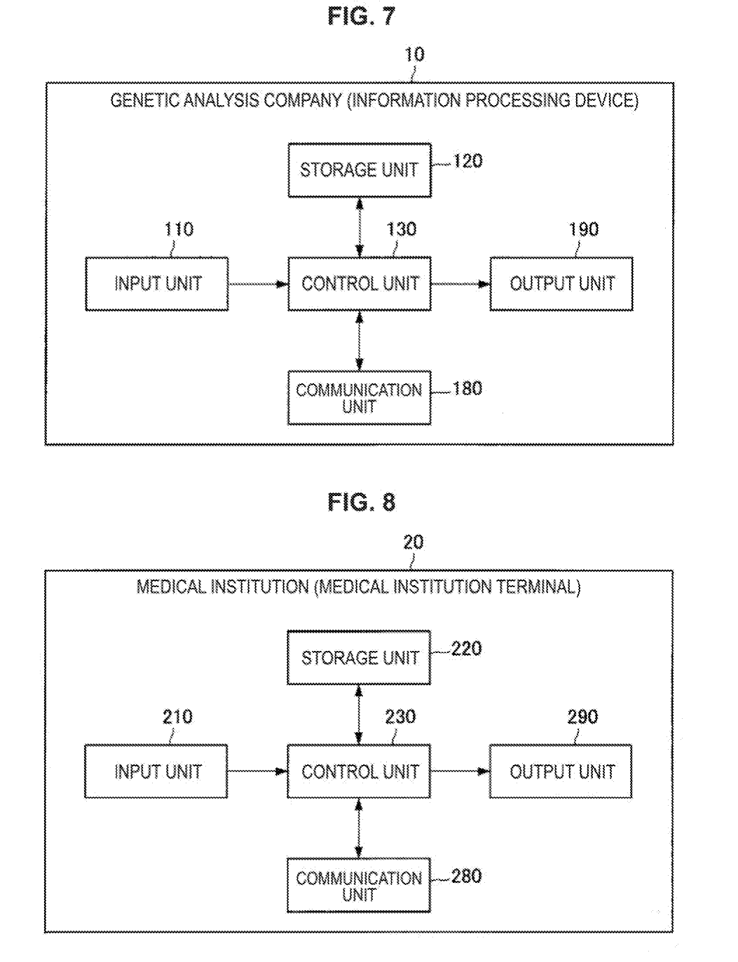

Subsequently, there will be described an exemplary functional configuration of an information processing device 10 according to an embodiment of the present disclosure. FIG. 7 illustrates the exemplary functional configuration of the information processing device 10 according to the embodiment of the present disclosure. As illustrated in FIG. 7, the information processing device 10 includes an input unit 110, a storage unit 120, a control unit 130, a communication unit 180, and an output unit 190.

The input unit 110 receives an operation performed by a user and outputs the received operation to the control unit 130. The input unit 110 may be configured with a touch panel, or may be configured with a hardware component other than the touch panel. Although the input unit 110 is integrated with the information processing device 10 in an example illustrated in FIG. 7, the input unit 110 may be provided separately from the information processing device 10.

The storage unit 120, using a storage medium such as a semiconductor memory or a hard disk, stores a program for operating the control unit 130. In addition, the storage unit 120 may store, for example, various data to be used by the program (for example, various setting information, content, etc.). Although the storage unit 120 is integrated with the information processing device 10 in the example illustrated in FIG. 7, the storage unit 120 may be provided separately from the information processing device 10.

The control unit 130 may correspond to a processor such as a CPU (Central Processing Unit), for example. In a case where the control unit 130 corresponds to a processor such as a CPU, such a processor may include an electronic circuit. The control unit 130 exhibits various functions included in the control unit 130 by executing programs stored in the storage unit 120 or other storage media.

The communication unit 180 is capable of communicating with other devices via a network. The form of communication performed by the communication unit 180 is not limited in particular, and may be wireless communication or wired communication. Although the communication unit 180 is integrated with the information processing device 10 in the example illustrated in FIG. 7, the communication unit 180 may be provided separately from the information processing device 10.

The output unit 190 outputs various information in accordance with the control performed by the control unit 130. The output unit 190 includes, for example, an LCD (Liquid Crystal Display), an organic EL (Electroluminescence) display unit, or the like. Although the output unit 190 is integrated with the information processing device 10 in the example illustrated in FIG. 7, the output unit 190 may be provided separately from the information processing device 10.

[1-3. Exemplary Functional Configuration of Medical Institution Terminal]

Subsequently, there will be described an exemplary functional configuration of a medical institution terminal 20 according to an embodiment of the present disclosure. FIG. 8 illustrates the exemplary functional configuration of the medical institution terminal 20 according to the embodiment of the present disclosure. As illustrated in FIG. 8, the medical institution terminal 20 includes an input unit 210, a storage unit 220, a control unit 230, a communication unit 280, and an output unit 290.

The input unit 210 receives an operation performed by a user and outputs the received operation to the control unit 230. The input unit 210 may be configured with a touch panel, or may be configured with a hardware component other than the touch panel. Although the input unit 210 is integrated with the medical institution terminal 20 in the example illustrated in FIG. 8, the input unit 210 may be provided separately from the medical institution terminal 20.

The storage unit 220, using a storage medium such as a semiconductor memory or a hard disk, stores a program for operating the control unit 230. In addition, the storage unit 220 may store, for example, various data to be used by the program (for example, various setting information, content, etc.). Although the storage unit 220 is integrated with the medical institution terminal 20 in the example illustrated in FIG. 8, the storage unit 220 may be provided separately from the medical institution terminal 20.

The control unit 230 may correspond to a processor such as a CPU (Central Processing Unit), for example. In a case where the control unit 230 corresponds to a processor such as a CPU, such a processor may include an electronic circuit. The control unit 230 exhibits various functions included in the control unit 230 by executing programs stored in the storage unit 220 or other storage media.

The communication unit 280 is capable of communicating with other devices via a network. The form of communication performed by the communication unit 280 is not limited in particular, and the communication performed by the communication unit 280 may be wireless communication or wired communication. Although the communication unit 280 is integrated with the medical institution terminal 20 in the example illustrated in FIG. 8, the communication unit 280 may be provided separately from the medical institution terminal 20.

The output unit 290 outputs various information in accordance with the control performed by the control unit 230. The output unit 290 includes, for example, an LCD (Liquid Crystal Display), an organic EL (Electroluminescence) display unit, or the like. Although the output unit 290 is integrated with the medical institution terminal 20 in the example illustrated in FIG. 8, the output unit 290 may be provided separately from the medical institution terminal 20.

[1-4. Exemplary Functional Configuration of Inspection Institution Terminal]

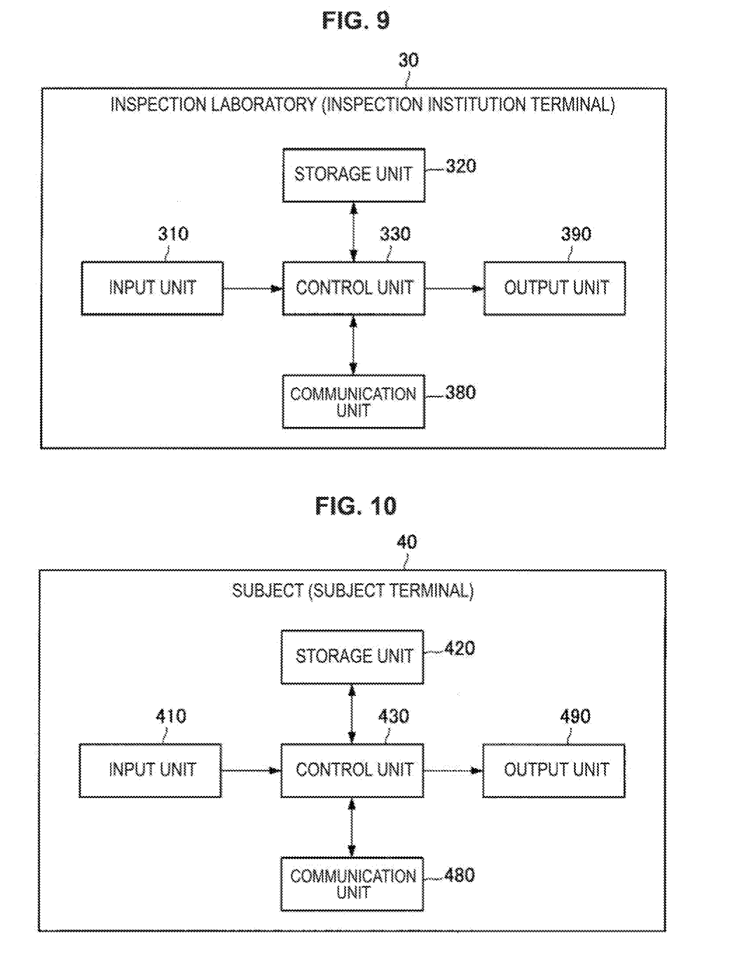

Subsequently, there will be described an exemplary functional configuration of an inspection institution terminal 30 according to an embodiment of the present disclosure. FIG. 9 illustrates an exemplary functional configuration of the inspection institution terminal 30 according to the embodiment of the present disclosure. As illustrated in FIG. 9, the inspection institution terminal 30 includes an input unit 310, a storage unit 320, a control unit 330, a communication unit 380, and an output unit 390.

The input unit 310 receives an operation performed by a user and outputs the received operation to the control unit 330. The input unit 310 may be configured with a touch panel, or may be configured with a hardware component other than the touch panel. Although the input unit 310 is integrated with the inspection institution terminal 30 in the example illustrated in FIG. 9, the input unit 310 may be provided separately from the inspection institution terminal 30.

The storage unit 320, using a storage medium such as a semiconductor memory or a hard disk, stores a program for operating the control unit 330. In addition, the storage unit 320 may store, for example, various data to be used by the program (for example, various setting information, content, etc.). Although the storage unit 320 is integrated with the inspection institution terminal 30 in the example illustrated in FIG. 9, the storage unit 320 may be provided separately from the inspection institution terminal 30.

The control unit 330 may correspond to a processor such as a CPU (Central Processing Unit), for example. In a case where the control unit 330 corresponds to a processor such as a CPU, such a processor may include an electronic circuit. The control unit 330 exhibits various functions included in the control unit 330 by executing programs stored in the storage unit 320 or other storage media.

The communication unit 380 is capable of communicating with other devices via a network. The form of communication performed by the communication unit 380 is not limited in particular, and the communication performed by the communication unit 380 may be wireless communication or may be wired communication. Although the communication unit 380 is integrated with the inspection institution terminal 30 in the example illustrated in FIG. 9, the communication unit 380 may be provided separately from the inspection institution terminal 30.

The output unit 390 outputs various information in accordance with the control performed by the control unit 330. The output unit 390 includes, for example, an LCD (Liquid Crystal Display), an organic EL (Electroluminescence) display unit, or the like. Although the output unit 390 is integrated with the inspection institution terminal 30 in the example illustrated in FIG. 9, the output unit 390 may be provided separately from the inspection institution terminal 30.

[1-5. Exemplary Functional Configuration of Subject Terminal]

Subsequently, there will be described an exemplary functional configuration of a subject terminal 40 according to an embodiment of the present disclosure. FIG. 10 illustrates the exemplary functional configuration of the subject terminal 40 according to the embodiment of the present disclosure. As illustrated in FIG. 10, the subject terminal 40 includes an input unit 410, a storage unit 420, a control unit 430, a communication unit 480, and an output unit 490.

The input unit 410 receives an operation performed by a user and outputs the received operation to the control unit 430. The input unit 410 may be configured with a touch panel, or may be configured with a hardware component other than the touch panel. Although the input unit 410 is integrated with the subject terminal 40 in the example illustrated in FIG. 10, the input unit 410 may be provided separately from the subject terminal 40.

The storage unit 420, using a storage medium such as a semiconductor memory or a hard disk, stores a program for operating the control unit 430. In addition, the storage unit 420 may store, for example, various data to be used by the program (for example, various setting information, content, etc.). Although the storage unit 420 is integrated with the subject terminal 40 in the example illustrated in FIG. 10, the storage unit 420 may be provided separately from the subject terminal 40.

The control unit 430 may correspond to a processor such as a CPU (Central Processing Unit), for example. In a case where the control unit 430 corresponds to a processor such as a CPU, such a processor may include an electronic circuit. The control unit 430 exhibits various functions included in the control unit 430 by executing programs stored in the storage unit 420 or other storage media.

The communication unit 480 is capable of communicating with other devices via a network. The form of communication performed by the communication unit 480 is not limited in particular, and the communication performed by the communication unit 480 may be wireless communication or may be wired communication. Although the communication unit 480 is integrated with the subject terminal 40 in the example illustrated in FIG. 10, the communication unit 480 may be provided separately from the subject terminal 40.

The output unit 490 outputs various information in accordance with the control performed by the control unit 430. The output unit 490 includes, for example, an LCD (Liquid Crystal Display), an organic EL (Electroluminescence) display unit, or the like. Although the output unit 490 is integrated with the subject terminal 40 in the example illustrated in FIG. 10, the output unit 490 may be provided separately from the subject terminal 40.

[1-6. Functional Details of Information Processing System]

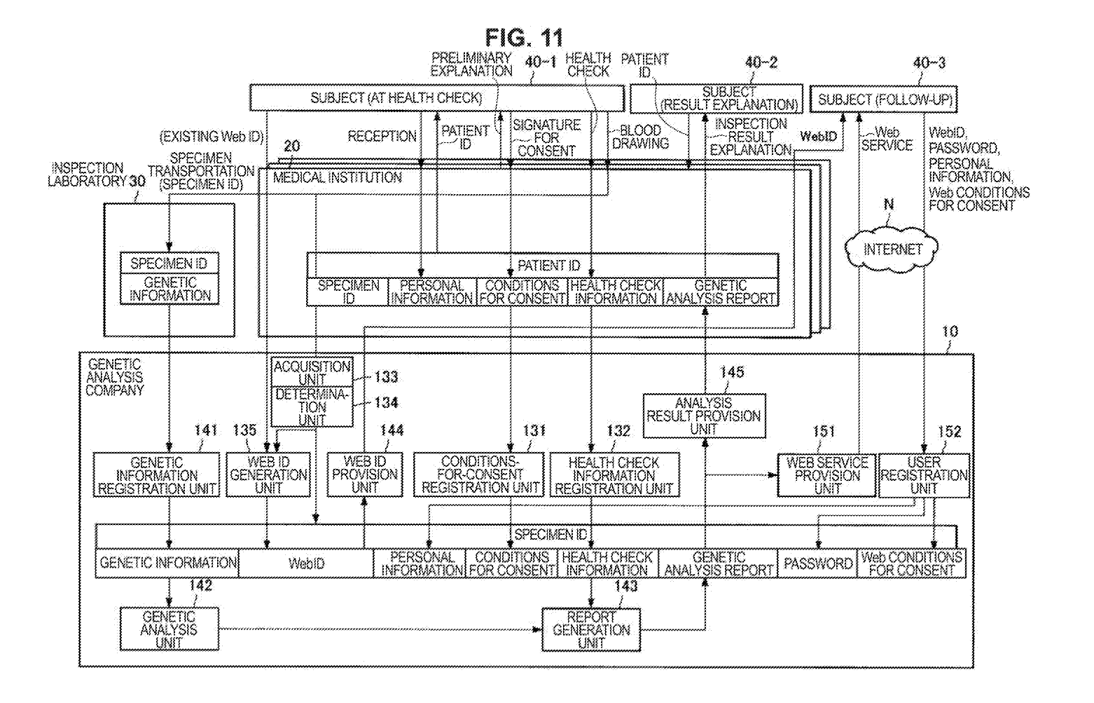

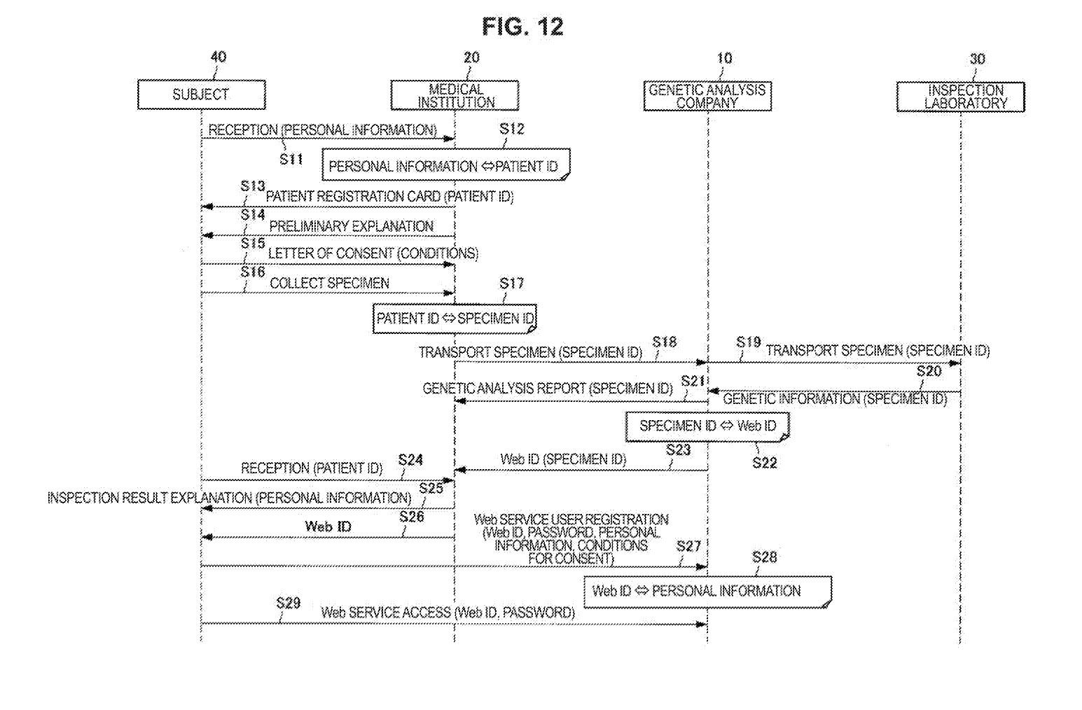

Subsequently, there will be described a technique for providing a more efficient coordination between a genetic analysis company and a medical institution. First, there will be described a case where personal information is not transferred from the medical institution to the genetic analysis company, referring to FIGS. 11 and 12. FIG. 11 illustrates a data flow when the personal information is not transferred from the medical institution to the genetic analysis company. In addition, FIG. 12 is a sequence diagram illustrating an operational flow of an information processing system when the personal information is not transferred from the medical institution to the genetic analysis company.

Among the blocks described in FIGS. 11 and 12 as a genetic analysis company 10, a medical institution 20, the inspection laboratory 30, and a subject 40, those in which the information processing device 10, the medical institution terminal 20, the inspection institution terminal 30, and the subject terminal 40 actually operate will be described below as operations of the information processing device 10, the medical institution terminal 20, the inspection institution terminal 30 and the subject terminal 40 as appropriate. In addition, each functional unit included in the genetic analysis company 10 in FIG. 11 is included in the control unit 130 of the information processing device 10.

First, a subject (at health check) 40-1 goes through reception of genetic analysis in the medical institution 20 (S11). On this occasion, personal information of the subject 40-1 is submitted to the medical institution 20. In the medical institution terminal 20, the submitted personal information is input via the input unit 210. In addition, the control unit 230 issues a patient ID for the subject 40-1 and associates the patient ID with the personal information (S12). Subsequently, the medical institution 20 passes a patient registration card bearing the patient ID to the subject 40-1 (S13), and provides the subject 40-1 with a preliminary explanation of the genetic analysis (S14).

Subsequently, when a letter of consent is submitted from the subject 40-1 to the medical institution 20 (S15), conditions for consent included in the submitted letter of consent are input via the input unit 210 in the medical institution terminal 20. In addition, health check information of the subject 40-1 input via the input unit 210 is stored in the storage unit 220 of the medical institution terminal 20. When the letter of consent is submitted, a specimen acquired from the subject 40-1 by blood drawing or the like is passed to the medical institution 20 (S16).

In addition, the control unit 230 issues a specimen ID and associates the specimen ID with the patient ID (S17), and the specimen provided with predetermined information is transported from the medical institution 20 to the genetic analysis company 10 (S18). The type of predetermined information is not limited, but the predetermined information may include at least the specimen ID. On this occasion, the predetermined information may also include the conditions for consent and the health check information and, in such a case, the conditions for consent are registered by a conditions-for-consent registration unit 131 and the health check information may be registered by a health-check-information registration unit 132.

Subsequently, an acquisition unit 133 acquires predetermined information provided to the aforementioned specimen, and a determination unit 134 determines whether or not personal information of the subject 40 has been set in the predetermined information. In the example illustrated in FIGS. 11 and 12, there is assumed a case where the personal information of the subject 40 has not been set in the predetermined information.

Subsequently, the specimen bearing the specimen ID is transported to the inspection laboratory 30 by the genetic analysis company 10 (S19), and a genetic analysis is performed on the specimen by the control unit 330 in the inspection institution terminal 30. The control unit 330 incorporates the specimen ID in the genetic information acquired by the genetic analysis, and the communication unit 380 transmits the genetic information including the specimen ID to the information processing device 10 (S20).

When the genetic information is received by the communication unit 180 in the information processing device 10, the genetic information is registered by a genetic information registration unit 141. A genetic analysis unit 142 then analyzes the genetic information to acquire a genetic analysis result, and a genetic analysis report including the genetic analysis result is generated by a report generation unit 143. Reference may be made to the health check information for generation of the genetic analysis report. In addition, the genetic analysis report may include the specimen ID. Here, when it is determined by the determination unit 134 that the personal information of the subject 40 has not been set in the predetermined information, an analysis result provision unit 145 may provide the medical institution terminal 20 with a genetic analysis report which does not include the personal information.

The genetic analysis report is transmitted to the medical institution terminal 20 by the communication unit 180 (S21). In addition, a Web ID generation unit 135 issues a Web ID and associates the issued Web ID with the specimen ID (S22). The Web ID is merely an example of user identification information of the service and therefore another user identification information may be used instead of the Web ID. Here, when it is determined by the determination unit 134 that the personal information of the subject 40 has not been set in the predetermined information, a Web ID provision unit 144 may provide the medical institution terminal 20 with a Web ID bearing the specimen ID (S23).

When a subject (result explanation) 40-2 visits the medical institution 20 again and goes through reception by presenting his/her patient registration card to notify the medical institution of his/her patient ID (S24), the medical institution 20 provides the subject 40-2 with an explanation of the inspection result (S25). When the Web ID is passed to the subject 40 (S26) via the medical institution terminal 20, a subject (follow-up) 40-3 is allowed to perform user registration of the Web service using his/her Web ID, password, personal information, and conditions for consent (S27). The password is merely an example of personal identification information and therefore any personal identification information other than a password may be used.

In the information processing device 10, when the communication unit 180 receives a service use request, a user registration unit 152 again registers the Web ID, the personal information, the password, and the conditions for consent, and associates the Web ID with the personal information (S28).

Subsequently, when a service use request including a Web ID is transmitted to the information processing device 10 by the communication unit 480 of the subject terminal 40-3, a Web service provision unit 151 of the information processing device 10 provides the Web service to the subject terminal 40. For example, when a Web service access using a Web ID and a password is performed by the communication unit 480 of the subject terminal 40-3 (when the service use request including the Web ID and the password is transmitted to the information processing device 10) (S29), the Web service provision unit 151 is capable of providing the Web service to the subject terminal 40.

Although there is illustrated an example of providing a Web service to the subject terminal 40 here, the service provided to the subject terminal 40 is not limited to Web services. In addition, the service provided to the subject terminal 40 is not limited and may include at least transmission of the genetic analysis result to the subject terminal 40. In addition, the information processing device 10 may acquire, via a Web service, personal information required for charging for the price of the service provision to the subject.

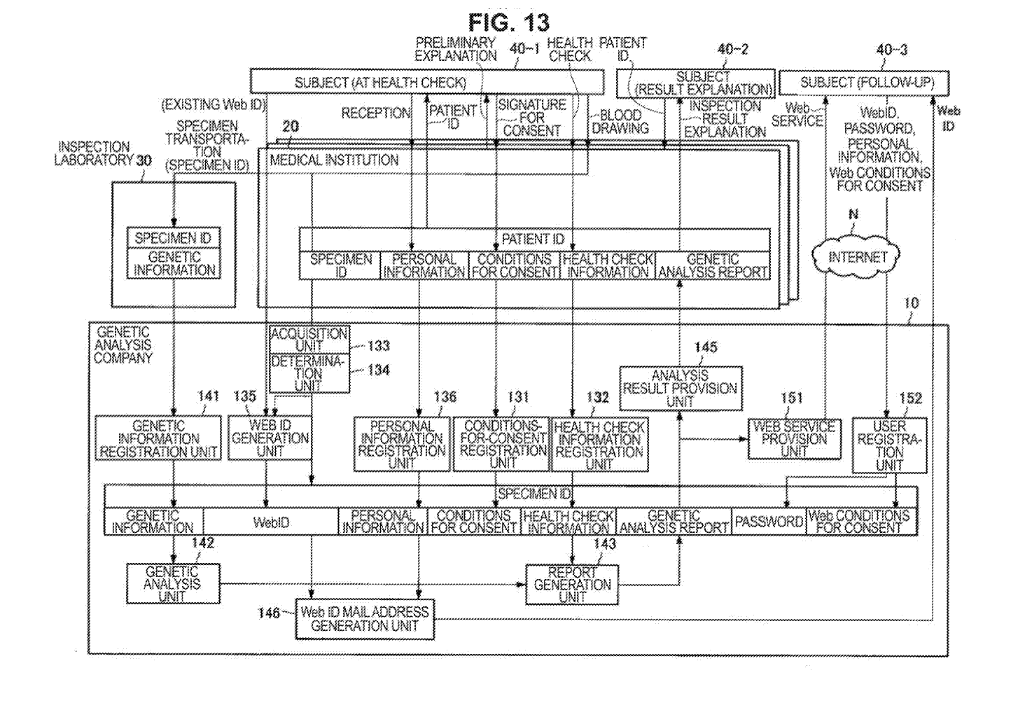

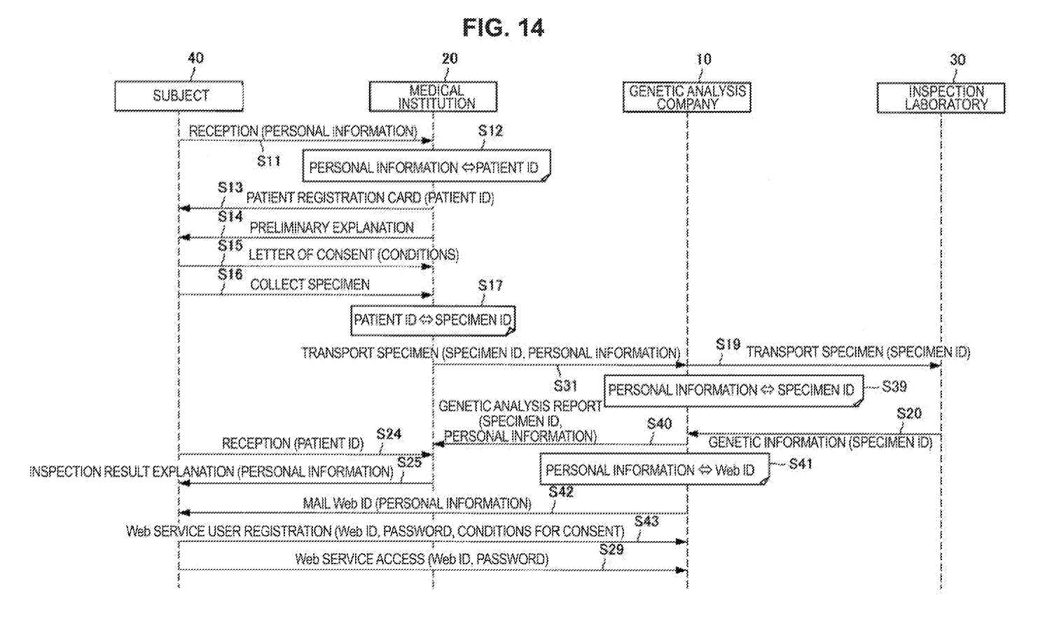

Subsequently, there will be described a case where personal information is transferred from a medical institution to a genetic analysis company, referring to FIGS. 13 and 14. FIG. 13 illustrates a data flow when the personal information is transferred from the medical institution to the genetic analysis company. In addition, FIG. 14 is a sequence diagram illustrating an operational flow of an information processing system when the personal information is transferred from the medical institution to the genetic analysis company.

Among the blocks described in FIGS. 13 and 14 as a genetic analysis company 10, a medical institution 20, the inspection laboratory 30, and a subject 40, those in which the information processing device 10, the medical institution terminal 20, the inspection institution terminal 30, and the subject terminal 40 actually operate will be described below as operations of the information processing device 10, the medical institution terminal 20, the inspection institution terminal 30 and the subject terminal 40 as appropriate. In addition, each functional unit included in the genetic analysis company 10 in FIG. 13 is included in the control unit 130 of the information processing device 10.

First, a subject (at health check) 40-1 goes through reception of genetic analysis in the medical institution 20 (S11). On this occasion, personal information of the subject 40-1 is submitted to the medical institution 20. In the medical institution terminal 20, the submitted personal information is input via the input unit 210. In addition, the control unit 230 issues a patient ID for the subject 40-1 and associates the patient ID with the personal information (S12). Subsequently, the medical institution 20 passes a patient registration card bearing the patient ID to the subject 40-1 (S13), and provides the subject 40-1 with a preliminary explanation of the genetic analysis (S14).

Subsequently, when a letter of consent is submitted from the subject 40-1 to the medical institution 20 (S15), conditions for consent included in the submitted letter of consent are input via the input unit 210 in the medical institution terminal 20. In addition, health check information of the subject 40-1 input via the input unit 210 is stored in the storage unit 220 of the medical institution terminal 20. When the letter of consent is submitted, a specimen acquired from the subject 40-1 by blood drawing or the like is passed to the medical institution 20 (S16).

In addition, the control unit 230 issues a specimen ID and associates the specimen ID with the patient ID (S17), and the specimen provided with predetermined information is transported from the medical institution 20 to the genetic analysis company 10 (S31). The type of predetermined information is not limited, but the predetermined information may include at least the specimen ID. On this occasion, the predetermined information may also include the conditions for consent and the health check information and, in such a case, the conditions for consent are registered by the conditions-for-consent registration unit 131 and the health check information may be registered by the health-check-information registration unit 132.

In addition, the control unit 130 associates the personal information with the specimen ID (S39). Subsequently, the acquisition unit 133 acquires predetermined information provided to the aforementioned specimen, and the determination unit 134 determines whether or not personal information of the subject 40 has been set in the predetermined information. In the example illustrated in FIGS. 13 and 14, there is assumed a case where the personal information of the subject 40 has been set in the predetermined information. In such a case, a personal information registration unit 136 may register the personal information.

Subsequently, the specimen bearing the specimen ID is transported to the inspection laboratory 30 by the genetic analysis company 10 (S19), and a genetic analysis is performed on the specimen by the control unit 330 in the inspection institution terminal 30. The control unit 330 incorporates the specimen ID in the genetic information acquired by the genetic analysis, and the communication unit 380 transmits the genetic information including the specimen ID to the information processing device 10 (S20).

When the genetic information is received by the communication unit 180 in the information processing device 10, the genetic information is registered by the genetic information registration unit 141. The genetic analysis unit 142 then analyzes the genetic information to acquire a genetic analysis result, and a genetic analysis report including the genetic analysis result is generated by the report generation unit 143. Reference may be made to the health check information for generation of the genetic analysis report. In addition, the genetic analysis report may include the specimen ID. Here, when it is determined by the determination unit 134 that the personal information of the subject 40 has been set in the predetermined information, the analysis result provision unit 145 may provide the medical institution terminal 20 with a genetic analysis report including the personal information.

The genetic analysis report is transmitted to the medical institution terminal 20 by the communication unit 180 (S40). In addition, the Web ID generation unit 135 issues a Web ID and associates the issued Web ID with the personal information (S41). The Web ID is merely an example of user identification information of the service and therefore another user identification information may be used instead of the Web ID. Here, when it is determined by the determination unit 134 that the personal information of the subject 40 has been set in the predetermined information, a Web ID mail address generation unit 146 may generate mail address information of the Web ID.

The mail address information of the Web ID may be generated in any way. When, for example, the personal information includes the subject's address information, the Web ID mail address generation unit 146 may extract address information from the personal information and generate mail address information on the basis of the extracted address information. More specifically, the Web ID mail address generation unit 146 may extract address information and name from the personal information and generate the mail address information in accordance with the extracted address information and name.

When the subject (result explanation) 40-2 visits the medical institution 20 again and goes through reception by presenting his/her patient registration card to notify the medical institution of his/her patient ID (S24), the medical institution 20 provides the subject 40-2 with an explanation of the inspection result (S25). When the Web ID is mailed (S42) from the genetic analysis company 10 on the basis of the mail address information, the subject (follow-up) 40-3 is allowed to perform user registration of the Web service using his/her Web ID, password, and conditions for consent (S43). The password is merely an example of personal identification information and therefore personal identification information other than passwords may be used.

In the information processing device 10, when the communication unit 180 receives a service use request, the user registration unit 152 registers the Web ID, the password and the conditions for consent (S43).

Subsequently, when a service use request including a Web ID is transmitted to the information processing device 10 by the communication unit 480 of the subject terminal 40-3, a Web service provision unit 151 of the information processing device 10 provides the Web service to the subject terminal 40. For example, when a Web service access using a Web ID and a password is performed by the communication unit 480 of the subject terminal 40-3 (when the service use request including the Web ID and the password is transmitted to the information processing device 10) (S29), the Web service provision unit 151 is capable of providing the Web service to the subject terminal 40.

Although there is illustrated an example of providing a Web service to the subject terminal 40 here, the service provided to the subject terminal 40 is not limited to Web services. In addition, the service provided to the subject terminal 40 is not limited and may include at least transmission of the genetic analysis result to the subject terminal 40. In addition, the information processing device 10 is capable of acquiring, via a Web service, information required for charging for the price of the service provision to the subject or required for immediate communication.

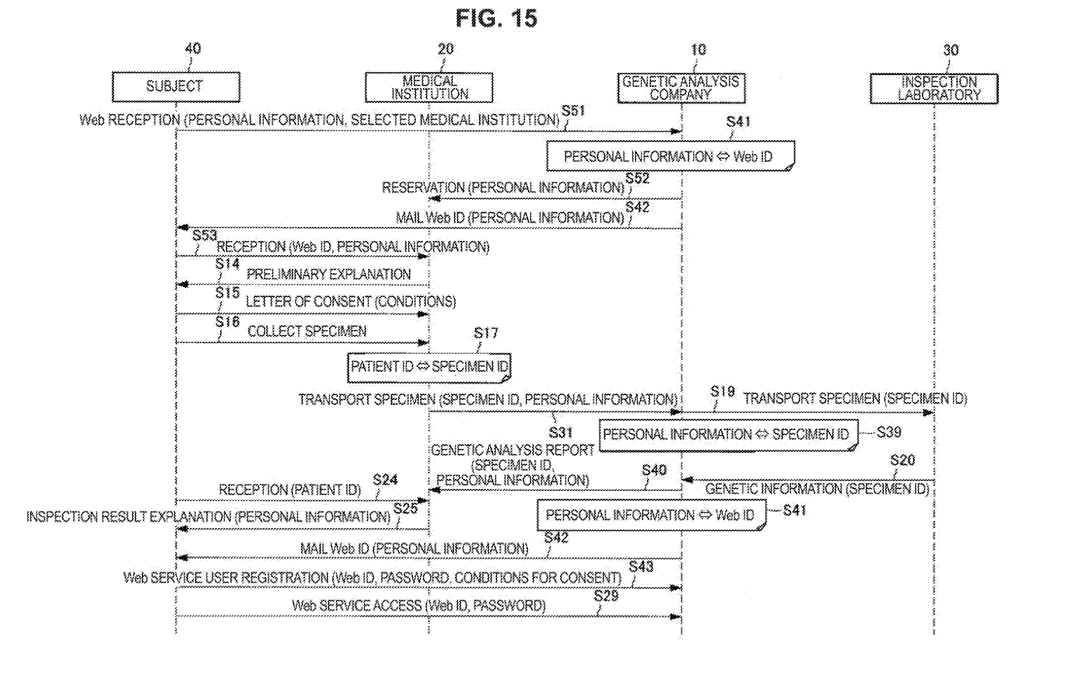

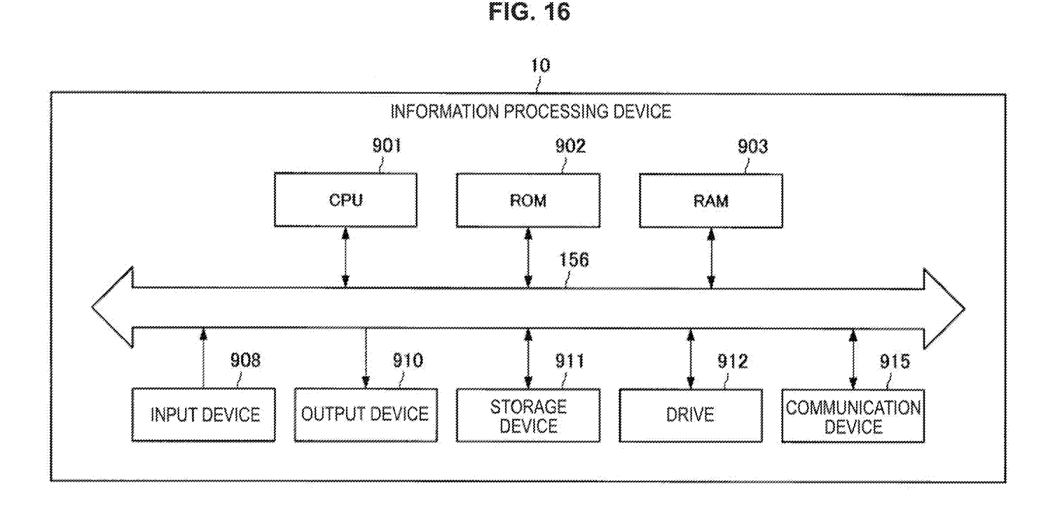

Subsequently, there will be described an exemplary application of the embodiment of the present disclosure, referring to FIG. 15. FIG. 15 is a sequence diagram illustrating an operational flow of the information processing system in the exemplary application of the embodiment of the present disclosure.

Among the blocks described in FIG. 15 as a genetic analysis company 10, a medical institution 20, the inspection laboratory 30, and a subject 40, those in which the information processing device 10, the medical institution terminal 20, the inspection institution terminal 30, and the subject terminal 40 actually operate will be described below as operations of the information processing device 10, the medical institution terminal 20, the inspection institution terminal 30 and the subject terminal 40 as appropriate.

First, the subject (at health check) 40-1 notifies the information processing device 10 of his personal information and a selected medical institution via Web reception (S51). The information processing device 10 issues a Web ID and associates the personal information with the Web ID (S41). Subsequently, the information processing device 10 reserves a genetic analysis at the medical institution 20 indicated by the selected medical institution on the basis of the personal information (S52), and generates mail address information of the Web ID.

When the Web ID is mailed to the subject 40 on the basis of the mail address information (S42), the subject 40 visits the medical institution 20 and goes through reception at the medical institution 20 using the mailed Web ID and the personal information (S53). Subsequent operations are similar to the sequence diagram illustrating the operational flow of the information processing system when personal information is transferred from the medical institution to the genetic analysis company illustrated in FIG. 14 and therefore explanation thereof is omitted.

The functional details of the information processing system according to the embodiments of the present disclosure have been thus described.

[1-7. Hardware Configuration Examples]

To continue, a hardware configuration example of the information processing device 10 according to an embodiment of the present disclosure will be described. FIG. 16 is a figure which shows a hardware configuration example of the information processing device 10 according to an embodiment of the present disclosure. However, the hardware configuration example shown in FIG. 16 merely shows an example of the hardware configuration of the information processing device 10. Therefore, the hardware configuration of the information processing device 10 is not limited to the example shown in FIG. 16.

As shown in FIG. 16, the information processing device 10 includes a CPU (Central Processing Unit) 901, a ROM (Read Only Memory) 902, a RAM (Random Access Memory) 903, an input device 908, an output device 910, a storage device 911, a drive 912, and a communication device 915.

The CPU 901 functions as an operation processing device and a control device, and controls all the operations within the information processing device 10 in accordance with various programs. Further, the CPU 901 may be a microprocessor. The ROM 902 stores programs and operation parameters used by the CPU 901. The RAM 903 temporarily stores programs used in the execution of the CPU 901, and parameters which arbitrary change in this execution. These sections are mutually connected by a host bus 156 constituted from a CPU bus or the like.

The input device 908 includes an input section, such as a mouse, a keyboard, a touch panel, buttons, a microphone, switches or leavers, for a user to input information, and an input control circuit which generates an input signal on the basis of an input by the user, and outputs the input signal to the CPU 901. By operating this input device 908, it is possible for the user of the information processing device 10 to input various data for the information processing device 10 and to instruct the process operations.

The output device 910 includes, for example, a display device such as a liquid crystal display (LCD) device, an OLED (Organic Light Emitting Diode) device, or a lamp. In addition, the output device 910 includes a sound output device such as a speaker or headphones. For example, the display device displays an imaged image or a generated image. On the other hand, the sound output device converts sound data and outputs sounds.

The storage device 911 is an device for data storage constituted as an example of a storage section of the information processing device 10. The storage device 911 may include a storage medium, a recording device which records data to the storage medium, a reading device which reads data from the storage medium, and an erasure device which erases data recorded in the storage medium. This storage device 911 stores programs executed by the CPU 901 and various data.

The drive 912 is a reader/writer for the storage medium, and is built into the information processing device 10 or is externally attached. The drive 912 reads information recorded on a removable storage medium, such as a mounted magnetic disk, an optical disk, a magneto-optical disk, or a semiconductor memory, and outputs the information to the RAM 903. Further, the drive 912 can write information to the removable storage medium.

The communication device 915 is, for example, a communication interface constituted by a communication device or the like for connecting to a network. Further, the communication device 915 may be a communication device adaptive to wireless LAN (Local Area Network), a communication device adaptive to LTE (Long Term Evolution), or a wired communication device which performs wired communication. For example, it is possible for the communication device 915 to communicate with other devices via a network.

The hardware configuration examples of the information processing device 10 according to the embodiment of the present disclosure have thus been described above. Although there have been described the hardware configuration examples of the information processing device 10 according to the embodiment of the present disclosure, the hardware configurations illustrated in FIG. 16 may also be employed as respective hardware configurations of the medical institution terminal 20, the inspection institution terminal 30, and the subject terminal 40.

### 2. CONCLUSION

According to the embodiment of the present disclosure, as has been discussed above, a subject is allowed to receive not only a genetic analysis service provided by a genetic analysis company but also a consultation service provided by an expert in a medical institution. On this occasion, it becomes possible to provide a more efficient coordination between the genetic analysis company and the medical institution.

More specifically, according to an embodiment of the present disclosure, regardless of whether the personal information is not transferred from the medical institution to the genetic analysis company or the personal information is transferred from the medical institution to the genetic analysis company, a follow-up service may be provided to the subject by the genetic analysis company. In addition, it is possible to acquire information required for charging on the price of service provision to the subject or required for immediate communication when providing a follow-up service.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, a program for causing hardware, such as a CPU, ROM and RAM built into a computer, to exhibit functions similar to the configuration included in the above described information processing device 10 can be created. Further, a recording medium can also be provided which records these programs and is capable of performing reading to the computer.

In addition, it is also possible to create a program for causing hardware components built in a computer such as a CPU, a ROM, and a RAM to exhibit functions equivalent to those of the components included in the medical institution terminal 20 described above. In addition, it is also possible to provide a computer-readable storage medium having the program stored thereon.

In addition, it is also possible to create a program for causing hardware components built in a computer such as a CPU, a ROM, and a RAM to exhibit functions equivalent to those of the components included in the inspection institution terminal 30 described above. In addition, it is also possible to provide a computer-readable storage medium having the program stored thereon.

In addition, it is also possible to create a program for causing hardware components built in a computer such as a CPU, a ROM, and a RAM to exhibit functions equivalent to those of the components included in the subject terminal 40 described above. In addition, it is also possible to provide a computer-readable storage medium having the program stored thereon.

In addition, for example, operations of the information processing system need not always be performed in the temporal order described in a sequence diagram or flowchart. For example, operations of the information processing system may be performed in a different order from the order described in the sequence diagram or flowchart, or at least a part of the operations described in the sequence diagram or flowchart may be performed in parallel.

Further, the effects described in this specification are merely illustrative or exemplified effects, and are not limitative. That is, with or in the place of the above effects, the technology according to the present disclosure may achieve other effects that are clear to those skilled in the art on the basis of the description of this specification.

Additionally, the present technology may also be configured as below.

(1)

An information processing device including:

a data acquisition unit configured to acquire predetermined information;

a determination unit configured to determine whether or not personal information of a subject has been set in the predetermined information; and

an identification information provision unit configured to provide a medical institution terminal with user identification information required when the subject uses a service, in a case where it is determined that the personal information of the subject has not been set in the predetermined information.

(2)

The information processing device according to (1),

wherein the predetermined information includes specimen identification information for identifying at least a specimen collected from the subject.

(3)

The information processing device according to (2),

wherein the identification information provision unit provides the medical institution terminal with the specimen identification information together with the user identification information.

(4)

The information processing device according to any one of (1) to (3), including

a mail address generation unit configured to generate mail address information of user identification information required when the subject uses a service, in a case where it is determined that the personal information of the subject has been set in the predetermined information.

(5)

The information processing device according to (4),

wherein the personal information includes at least address information of the subject.

(6)

The information processing device according to (5),

wherein the mail address generation unit generates the mail address information on the basis of the address information extracted from the personal information.

(7)

The information processing device according to any one of (1) to (6), including

an analysis result provision unit configured to provide the medical institution terminal with a genetic analysis result that does not include the personal information, in a case where it is determined that the personal information of the subject has not been set in the predetermined information.

(8)

The information processing device according to (7),

wherein the analysis result provision unit provides the medical institution terminal with the genetic analysis result including the personal information, in a case where it is determined that the personal information of the subject has been set in the predetermined information.

(9)

The information processing device according to (7) or (8), including an analysis unit configured to acquire the genetic analysis result by analyzing genetic information acquired from an inspection institution terminal.

(10)

The information processing device according to (9),

wherein the analysis unit incorporates, in the genetic analysis result, specimen identification information which has been set in the genetic information.

(11)

The information processing device according to (9) or (10),

wherein the genetic information includes information for identifying a gene included in a specimen collected from the subject.

(12)

The information processing device according to any one of (7) to (11),

wherein the genetic analysis result includes at least information indicating a likelihood of the subject getting a predetermined disease.

(13)

The information processing device according to any one of (1) to (12), including

a service provision unit configured to provide the subject terminal with the service, in a case where a service use request including the user identification information is received from a subject terminal.

(14)

The information processing device according to (13),

wherein the service provided to the subject terminal includes at least transmission of a genetic analysis result to the subject terminal.

(15)

The information processing device according to (13) or (14), including

a user registration unit configured to register the user identification information and personal identification information, in a case where a user registration request including the user identification information and the personal identification information is received from the subject terminal,

wherein the service provision unit provides the subject terminal with the service, in a case where the service use request including the user identification information and the personal identification information is received.

(16)

An information processing method including:

acquiring predetermined information;

determining whether or not personal information of a subject has been set in the predetermined information; and

providing a medical institution terminal with user identification information required when the subject uses a service, in a case where it is determined that the personal information of the subject has not been set in the predetermined information.

(17)

A program for causing a computer to function as an information processing device including:

a data acquisition unit configured to acquire predetermined information;

a determination unit configured to determine whether or not personal information of a subject has been set in the predetermined information; and

an identification information provision unit configured to provide a medical institution terminal with user identification information required when the subject uses a service, in a case where it is determined that the personal information of the subject has not been set in the predetermined information.

(18)

An information processing system including:

an information processing device including
a data acquisition unit configured to acquire predetermined information,
a determination unit configured to determine whether or not personal information of a subject has been set in the predetermined information, and
an identification information provision unit configured to provide user identification information required when the subject uses a service, in a case where it is determined that the personal information of the subject has not been set in the predetermined information;

a medical institution terminal including
a communication unit configured to receive the user identification information from the information processing device; and

a subject terminal including
a communication unit configured to transmit a service use request including the user identification information to the information processing device.

### REFERENCE SIGNS LIST

10 information processing device (genetic analysis company)
110 input unit
120 storage unit
130 control unit
131 conditions-for-consent registration unit
132 health check information registration unit
133 acquisition unit
134 determination unit
141 genetic information registration unit
142 genetic analysis unit
143 report generation unit
145 analysis result provision unit
135 Web ID generation unit
144 Web ID provision unit
152 user registration unit
151 Web service provision unit
136 personal information registration unit
146 Web ID mail address generation unit
180 communication unit
190 output unit
20 medical institution terminal (medical institution)
210 input unit
220 storage unit
230 control unit
280 communication unit
290 output unit
30 inspection institution terminal (inspection laboratory)
310 input unit
320 storage unit
330 control unit
380 communication unit
390 output unit
40 subject terminal (subject)
410 input unit
420 storage unit
430 control unit
480 communication unit
490 output unit

1. An information processing device comprising:
a data acquisition unit configured to acquire predetermined information;
a determination unit configured to determine whether or not personal information of a subject has been set in the predetermined information; and
an identification information provision unit configured to provide a medical institution terminal with user identification information required when the subject uses a service, in a case where it is determined that the personal information of the subject has not been set in the predetermined information.

2. The information processing device according to claim 1,
wherein the predetermined information includes specimen identification information for identifying at least a specimen collected from the subject.

3. The information processing device according to claim 2,
wherein the identification information provision unit provides the medical institution terminal with the specimen identification information together with the user identification information.

4. The information processing device according to claim 1, comprising
a mail address generation unit configured to generate mail address information of user identification information required when the subject uses a service, in a case where it is determined that the personal information of the subject has been set in the predetermined information.

5. The information processing device according to claim 4,
wherein the personal information includes at least address information of the subject.

6. The information processing device according to claim 5,
wherein the mail address generation unit generates the mail address information on the basis of the address information extracted from the personal information.

7. The information processing device according to claim 1, comprising
an analysis result provision unit configured to provide the medical institution terminal with a genetic analysis result that does not include the personal information, in a case where it is determined that the personal information of the subject has not been set in the predetermined information.

8. The information processing device according to claim 7,
wherein the analysis result provision unit provides the medical institution terminal with the genetic analysis result including the personal information, in a case where it is determined that the personal information of the subject has been set in the predetermined information.

9. The information processing device according to claim 7, comprising
an analysis unit configured to acquire the genetic analysis result by analyzing genetic information acquired from an inspection institution terminal.

10. The information processing device according to claim 9,
wherein the analysis unit incorporates, in the genetic analysis result, specimen identification information which has been set in the genetic information.

11. The information processing device according to claim 9,
wherein the genetic information includes information for identifying a gene included in a specimen collected from the subject.

12. The information processing device according to claim 7,
wherein the genetic analysis result includes at least information indicating a likelihood of the subject getting a predetermined disease.

13. The information processing device according to claim 1, comprising
a service provision unit configured to provide the subject terminal with the service, in a case where a service use request including the user identification information is received from a subject terminal.

14. The information processing device according to claim 13,
wherein the service provided to the subject terminal includes at least transmission of a genetic analysis result to the subject terminal.

15. The information processing device according to claim 13, comprising
a user registration unit configured to register the user identification information and personal identification information, in a case where a user registration request including the user identification information and the personal identification information is received from the subject terminal,
wherein the service provision unit provides the subject terminal with the service, in a case where the service use request including the user identification information and the personal identification information is received.

16. An information processing method comprising:
acquiring predetermined information;
determining whether or not personal information of a subject has been set in the predetermined information; and
providing a medical institution terminal with user identification information required when the subject uses a service, in a case where it is determined that the personal information of the subject has not been set in the predetermined information.

17. A program for causing a computer to function as an information processing device including:
a data acquisition unit configured to acquire predetermined information;
a determination unit configured to determine whether or not personal information of a subject has been set in the predetermined information; and
an identification information provision unit configured to provide a medical institution terminal with user identification information required when the subject uses a service, in a case where it is determined that the personal information of the subject has not been set in the predetermined information.

18. An information processing system comprising:
an information processing device including
a data acquisition unit configured to acquire predetermined information,
a determination unit configured to determine whether or not personal information of a subject has been set in the predetermined information, and
an identification information provision unit configured to provide user identification information required when the subject uses a service, in a case where it is determined that the personal information of the subject has not been set in the predetermined information;
a medical institution terminal including
a communication unit configured to receive the user identification information from the information processing device; and
a subject terminal including
a communication unit configured to transmit a service use request including the user identification information to the information processing device.
